(19) United States
(12) Patent Application Publication
(10) Pub. No.: US 2026/0170149 A1
(43) Pub. Date: Jun. 18, 2026

(54) SYSTEMS AND METHODS FOR EXPLOITING CLASS PROBABILITIES FOR BLACK-BOX SENTENCE-LEVEL ATTACKS

(71) Applicants: Raha Moraffah, Chandler, AZ (US); Huan Liu, Tempe, AZ (US)

(72) Inventors: Raha Moraffah, Chandler, AZ (US); Huan Liu, Tempe, AZ (US)

(73) Assignee: Arizona Board of Regents on Behalf of Arizona State University, Tempe, AZ (US)

(21) Appl. No.: 19/383,398

(22) Filed: Nov. 7, 2025

Related U.S. Application Data
(60) Provisional application No. 63/717,787, filed on Nov. 7, 2024.

(51) Int. Cl. G06F 21/57

(52) U.S. Cl. CPC G06F 21/577; G06F 2221/033

(57) ABSTRACT

Systems and methods described herein assess the robustness of text classifiers in a black-box, score-based setting including algorithmically implementing class probabilities for black-box sentence-level attacks. In one example, a correctly classified input sentence is encoded into a latent representation, and a continuous search space of adversarial paraphrases is formed by perturbing that representation using a text variational autoencoder. Candidate sentences decoded from the perturbed representations are submitted to a target classifier to obtain class-probability vectors. An adversarial loss, including a misclassification term and a semantic-similarity constraint, is computed from the probabilities. Distribution parameters are updated with natural evolution strategies using only score feedback, yielding, within a query budget, semantically similar sentences that the classifier misclassifies. Extensive evaluations of the proposed attack comparing with the baselines across various classifiers and benchmark datasets are further included.

### CROSS REFERENCE TO RELATED APPLICATIONS

This is a non-provisional application that claims benefit to U.S. Provisional Application Ser. No. 63/717,787, filed on Nov. 7, 2024, which is herein incorporated by reference in its entirety.

### GOVERNMENT SUPPORT

This invention was made with government support under W911NF-20-2-0124 awarded by the Army Research Laboratory and under W911NF-21-1-0030 awarded by the Army Research Office. The government has certain rights in the invention.

### FIELD

The present disclosure generally relates to machine learning including classifiers and related concepts; and in particular to methods for providing insights into the vulnerability of text classifiers deployed in real-world applications by, e.g., leveraging class probabilities.

### BACKGROUND

Sentence-level attacks craft adversarial sentences that are synonymous with correctly-classified sentences but are misclassified by the text classifiers. Under the black-box setting, classifiers are only accessible through their feedback to queried inputs, which is predominately available in the form of class probabilities. Even though utilizing class probabilities results in stronger attacks, due to the challenges of using them for sentence-level attacks, existing attacks use either no feedback or only the class labels.

It is with these observations in mind, among others, that various aspects of the present disclosure were conceived and developed.

### SUMMARY

The present disclosure provides a number of examples that describe features and aspects associated with providing insights into the vulnerability of text classifiers deployed in real-world applications by, e.g., leveraging class probabilities. In the context of the disclosed methods, devices, techniques, apparatus, systems, and so on, the terms “operable to,” “configured to,” and “capable of” used herein are interchangeable.

In an initial set of illustrative examples, the present disclosure can take the form of a method for score-based black-box sentence-level attack that is specifically designed to assess the security vulnerability of prevalent text classifiers deployed in real-world applications. In particular, the method can include steps or operations for assessing the security vulnerability of a machine learning model operating in a black-box score-based setting, comprising: (a) receiving an input sentence that a text classifier correctly classifies; (b) generating, based on the input sentence, one or more candidate sentence-level variants that are intended to be semantically similar to the input sentence; (c) for each candidate sentence-level variant, querying the text classifier and obtaining a class-probability vector as feedback; (d) computing an adversarial loss for the candidate sentence-level variant as a function of the obtained class-probability vector, the adversarial loss increasing as the probability of a non-original class increases and decreasing as the probability of the original class increases; (e) updating a generation policy for the candidate sentence-level variants based at least on the class-probability vectors so as to produce, in subsequent iterations, candidate sentence-level variants more likely to be misclassified by the text classifier; and (f) determining that the text classifier is vulnerable when a candidate sentence-level variant is misclassified while satisfying a semantic-similarity threshold relative to the input sentence to provide score-driven, sentence-level robustness evaluation that exploits class-probability feedback.

In another set of illustrative examples, the inventive concept can take the form of a system defining a variational autoencoder-based architecture to model the distribution of potential adversarial sentences. In particular, the system can include components for modeling a distribution of potential adversarial sentences for improved classifier vulnerability assessment, comprising: one or more processors and memory storing instructions executable by the one or more processors to: (a) implement a text variational autoencoder (VAE) latent variable model configured to model sentence distribution and having an encoder and a decoder; (b) obtain, for an input sentence, a latent representation using the encoder; (c) parameterize an adversarial latent distribution as a perturbation of the latent representation, the perturbation drawn from a distribution having parameters including a mean vector and a variance; and (d) sample latent variables from the adversarial latent distribution and decode the sampled latent variables via the decoder to produce candidate adversarial sentences representing a continuous, explorable search space of sentence-level variants that accommodates a continuous, parameterized search space in latent space to support score-guided exploration and preserve fluency and semantics, thereby improving effectiveness of classifier vulnerability assessment.

In another set of illustrative examples, the inventive concept can take the form of a method for natural evolution strategy based optimization. In particular, the method can include a computer-implemented method for optimizing parameters of an adversarial sentence distribution using natural evolution strategies (NES) with class-probability feedback, the method comprising: (a) parameterizing a candidate adversarial distribution over sentence representations with parameters including a mean vector μ and optionally a variance σ²; (b) sampling a population of representations from the adversarial distribution and decoding the sampled representations to candidate sentences; (c) querying a black-box text classifier for each candidate sentence to obtain class-probability vectors; (d) computing an adversarial loss for each candidate sentence as a function of the class-probability vectors; (e) estimating, using a natural-evolution-strategies estimator, a gradient of an expected adversarial loss with respect to the parameters of the adversarial distribution; and (f) updating at least the mean vector μ according to the estimated gradient to reduce the expected adversarial loss, and repeating steps (b)-(f) until a stopping criterion is met; thereby enabling gradient-free optimization that relies only on score feedback, improving convergence and/or query efficiency for sentence-level black-box attacks relative to heuristic selection or decision-only search.

The foregoing examples broadly outline various aspects, features, and technical advantages of examples according to the disclosure in order that the detailed description that follows may be better understood. It is further appreciated that the above operations described in the context of the illustrative example method, device, and computer-readable medium are not required and that one or more operations may be excluded and/or other additional operations discussed herein may be included. Additional features and advantages will be described hereinafter. The conception and specific examples illustrated and described herein may be readily utilized as a basis for modifying or designing other structures for carrying out the same purposes of the present disclosure. Such equivalent constructions do not depart from the spirit and scope of the appended claims.

### BRIEF DESCRIPTION OF THE DRAWINGS

FIG. 1A illustrates an example system for implementing a framework that provides insights into the vulnerability of text classifiers deployed in real-world applications by, e.g., leveraging class probabilities among other aspects described herein.

FIG. 1B is an illustration associated with the framework of FIG. 1A showing an overview of the S2B2-Attack referenced herein. S2B2-Attack perturbs original latent variable distributions to model the search space of candidate distributions of adversarial examples using VAE and learns the parameters of the actual adversarial distribution using the NES search based on the classifier's class probabilities.

FIG. 2A is a graph illustrating the effect of semantic similarity constraint on S2B2-Attack's performance focusing on attack success rate with the classifier being Robert.

FIG. 2B is a graph illustrating the effect of semantic similarity constraint on S2B2-Attack's performance focusing on use with the classifier being Robert.

FIG. 3 is a process flow of an example method associated with the S2B2-Attack concepts described herein.

FIG. 4 is a process flow of an example method associated with the variational autoencoder architecture concepts described herein.

FIG. 5 is a process flow of an example method associated with the natural evolution strategy based optimization concepts described herein.

Corresponding reference characters indicate corresponding elements among the view of the drawings. The headings used in the figures do not limit the scope of the claims.

### DETAILED DESCRIPTION

The present disclosure relates to a computer-implemented framework (e.g., systems and methods) that leverages one or more processors configured to assess the security vulnerability of prevalent text classifiers deployed in real-world applications. In one example, the framework can be implemented as a system including a processor that executes software and/or machine executable instructions described herein, i.e., takes a sequence of benign correctly classified texts, and crafts corresponding sentences that are synonymous with the benign inputs but are misclassified by the classifiers. The system then assesses the security vulnerability of text classifiers. By leveraging class probabilities, the system provides an increase in the success rate of sentence level attacks.

Sentence-level attacks craft adversarial sentences that are synonymous with correctly-classified sentences but are misclassified by the text classifiers. Under the black-box setting, classifiers are only accessible through their feedback to queried inputs, which is predominately available in the form of class probabilities. Even though utilizing class probabilities results in stronger attacks, due to the challenges of using them for sentence-level attacks, existing attacks use either no feedback or only the class labels. Overcoming the challenges, the present disclosure illustrates a novel algorithm that uses class probabilities for black-box sentence-level attacks, investigates the effectiveness of using class probabilities on the attack's success, and examine the question if it is worthy or practical to use class probabilities by black-box sentence-level attacks. Extensive evaluations of the proposed attack comparing with the baselines across various classifiers and benchmark datasets were conducted as described herein.

Exemplary features of the framework include the following:
Score-based black-box sentence-level attack that is specifically designed to assess the security vulnerability of prevalent text classifiers deployed in real-world applications.
Variational autoencoder-based architecture to model the distribution of potential adversarial sentences.
Natural evolution strategy based optimization to search the space of potential disruption to identify the actual adversarial disruption.

The inventive concept demonstrates effectiveness and practicality of using class probabilities for conducting black-box sentence-level attacks. The Findings of the Association for Computational Linguistics includes data showing a roughly 15% improvement over the state-of-the-art decision based attack.

### 1 Introduction

Despite the tremendous success of text classification models (Devlin et al., 2018; Liu et al., 2019), studies have exposed their susceptibility to adversarial examples, i.e., carefully crafted sentences with human-unrecognizable changes to the inputs that are misclassified by the classifiers (Zhang et al., 2020). Adversarial attacks provide profound insights into the classifiers' brittleness and are key to reinforcing their robustness and reliability.

Adversarial attacks on texts are broadly categorized into two types, namely word-level and sentence-level attacks. Word-level attacks manipulate the words in the original sentences to examine the text classifiers' sensitivity to the choice of words in sentences (Jin et al., 2020; Li et al., 2020c; Zang et al., 2019; Alzantot et al., 2018a). Sentence-level attacks, on the other hand, craft synonymous sentences with the original correctly-classified inputs, such that they are misclassified by classifiers.

Depending on the information available to the adversary, the attacks are conducted under the white-box or black-box settings. Unlike the white-box setting, where the classifier is completely known, and the adversary uses its gradients to craft adversarial examples (Wang et al., 2019; Guo et al., 2021), black-box attacks can only access the classifier feedback to queries. Having no prior knowledge of the classifier, this setting is more feasible for real-world applications.

Under the black-box setting, three types of classifier feedback exist: (1) no feedback (blind setting): classifiers deny any feedback to the adversaries; (2) class label feedback (decision-based setting): classifiers return their final decisions in the forms of the predicted class labels; and (3) class probability feedback (score-based setting): classifiers return the class probabilities as feedback in response to queries. Among these settings, the score-based is the most prevalent setting in real-world applications. For instance, Microsoft Azure® and Meta-Mind are two widely-used real-world online text classification models that are deployed under the score-based setting and return class probabilities. When available, class probabilities provide richer information compared to no feedback or solely the class labels, which can better guide the adversarial example generation and result in stronger attacks. This is also demonstrated by the success of score-based word-level attacks (Lee et al., 2022; Maheshwary et al., 2021) compared to their blind (Emmery et al., 2021; Emelin et al., 2020) or decision-based counterparts (Yuan et al., 2021; Yu et al., 2022). Moreover, developing score-based black-box sentence-level attacks is a critical step toward identifying the extent of the threat to the text classification models to better immunize them to attacks in all black-box settings. Therefore, studying such attacks is of great importance.

Existing black-box sentence-level attacks either do not use the feedback (blind) (lyyer et al., 2018; Huang and Chang, 2021) or only use the class labels (decision-based) (Zhao et al., 2017; Chen et al., 2021), hence do not fully exploit the class probability feedback available under the most prevalent score-based setting. This is because utilizing the classifier's class probabilities available under the score-based settings for black-box sentence-level attacks faces the following challenges: (i) Defining the search space. In a score-based setting, an ideal search space is a continuous explorable space that represents the sentence-level candidates and how the transition from one candidate to another can be made using the classifier's class probabilities. Existing sentence-level search spaces based on paraphrase generation (lyyer et al., 2018; Ribeiro et al., 2018) or generative adversarial networks (Zhao et al., 2017) that are developed for blind or decision-based settings are discrete, i.e., they only generate sentence-level adversarial candidates with undefined relationships. These search spaces are therefore not appropriate for the score-based setting; and (ii) Developing a score-based search method. In black-box settings, a successful attack needs to fully exploit the classifier feedback to guide exploring the search space. Existing search methods used for sentence-level attacks are heuristic iterative methods. These methods only accept/reject the adversarial example candidates based on their returned class labels (misclassified or not) (Zhao et al., 2017) and do not use the class probabilities, as required by the score-based setting. For the score-based sentence-level attacks, we need a search method that uses class probabilities.

Subduing these challenges, the first score-based black-box sentence-level attack is described herein that models the candidate distributions of adversarial sentences, which transforms the problem to search over the continuous parameter space of these distributions instead of the discrete space of synonymous sentences with undefined relationships. It then searches for the optimal parameters of the actual adversarial distribution using the black-box classifier's class probabilities. To evaluate the framework, extensive experiments were conducted on three text classification classifiers across three benchmark datasets. The contributions are summarized as follows:
It is believed the present disclosure details the first attempt to study the effectiveness and practicality of using class probabilities for black-box sentence-level attacks.
A novel score-based black-box sentence-level attack is proposed that learns the distribution of sentence-level adversarial examples using the classifier's class probabilities.
Extensive experiments were conducted on various classifiers and datasets that demonstrate under the score-based setting, the attack outperforms all state-of-the-art sentence-level attacks by fully exploiting class probabilities.

### 2 Related Work

Word-level Attacks. These attacks alter certain words in the original sentences to get them misclassified by the classifier. The search space in these attacks consists of adversarial candidates generated by applying transformations to the words in a sentence. To form these search spaces, various word replacement strategies such as context-free (Alzantot et al., 2018b; Ren et al., 2019; Zang et al., 2019; Jin et al., 2020) and context-aware (Garg and Ramakrishnan, 2020; Li et al., 2020c,b) approaches have been proposed. For the search method, these attacks mainly rely on methods that are designed to deal with their discrete word-level search spaces such as word ranking-based methods (Ren et al., 2019; Jin et al., 2020; Garg and Ramakrishnan, 2020; Maheshwary et al., 2021; Malik et al., 2021), or combinatorial optimization based methods like gradient-free population-based optimization (Alzantot et al., 2018b), or particle swarm optimization (Zang et al., 2019). These attacks focus on a different granularity of the attack compared to the attack studied in this disclosure.

Sentence-level Attacks Sentence-level attacks generate adversarial paraphrases of the original sentences that are misclassified by the classifier. Under the white-box setting, where the adversary has complete access to classifiers, these attacks adopt the classifier's gradients for the attack generation (Wang et al., 2019; Xu et al., 2021; Le et al., 2020). Under the more realistic black-box setting, where only the classifier's feedback to queries is accessible, these attacks are categorized into three: (i) Blind attacks, which do not utilize the classifier feedback and use the paraphrases of the original sentences as adversarial examples (lyyer et al., 2018; Huang and Chang, 2021); (ii) Decision-based attacks that only utilize the final decision of the classifiers (i.e., the class labels). These attacks iteratively craft adversarial example candidates until they are misclassified by the classifier. These attacks use conditional text generation methods based on GAN (Zhao et al., 2017) or paraphrase generation methods (Ribeiro et al., 2018; Chen et al., 2021) to generate adversarial candidates and adopt heuristic iterative search methods to identify the actual adversarial example; and (iii) Score-based attacks, which use the classifier's class probabilities to guide the attack generation. Blind and Decision-based attacks do not fully utilize the class probability feedback, hence underperform in this setting. Due to the challenges of characterizing the search space and developing an appropriate search method, it has not been explored in the previous literature. It is believed that MAYA (Chen et al., 2021) is the only sentence-level attack proposed for this setting. However, due to its discrete search space, this method only uses the classifier feedback to choose the sentence with the lowest class probability from the discrete space of potential sentences. This underutilizes the class probability information, which could be utilized to guide the generation of the new adversarial candidate from the previous one, if the search space was continuous, i.e., the relationships between two sentences were well-defined.

### 3 Methodology

### 3.1 Problem Statement

Let F: X→Y be a text classifier that takes in a text x∈X and maps it to a label y∈Y. The goal of the textual adversarial attack is to generate an adversarial example

$${x}_{adv}^{*}$$

which is semantically similar to x but is misclassified by the classifier, i.e.

$$F ( {x}_{adv}^{*} ) \neq F ( x ) : {x}_{adv}^{*} = {arg min}_{{x}^{*} ∈ 𝒮 ( x )} ℒ ( {x}^{*} ) \qquad ( 1 )$$

where S(x) is a set of semantically similar samples to the original x and [symbol] (x*) is the adversarial loss evaluated by the classifier feedback.

We concentrate on black-box sentence-level attacks, in which S(x) consists of adversarial examples synonymous with the original sentences. Under the score-based black-box setting, we assume access to the class probabilities of the classifier. We adopt the C&W loss (Nicholas Carlini and David Wagner. 2017. “Towards evaluating the robustness of neural networks.” IEEE) as the loss used in Eq. (1). The C&W loss is defined as

$$ℒ ( {x}^{*} ) = max \{ 0 , log F {( {x}^{*} )}_{y} - {max log}_{i \neq y} ( {F ( {x}^{*} )}_{i} ) \}$$

where F(x*)ⱼ is the j-th probability output of the classifier, y is the correct label index.

### 3.2 Proposed Framework

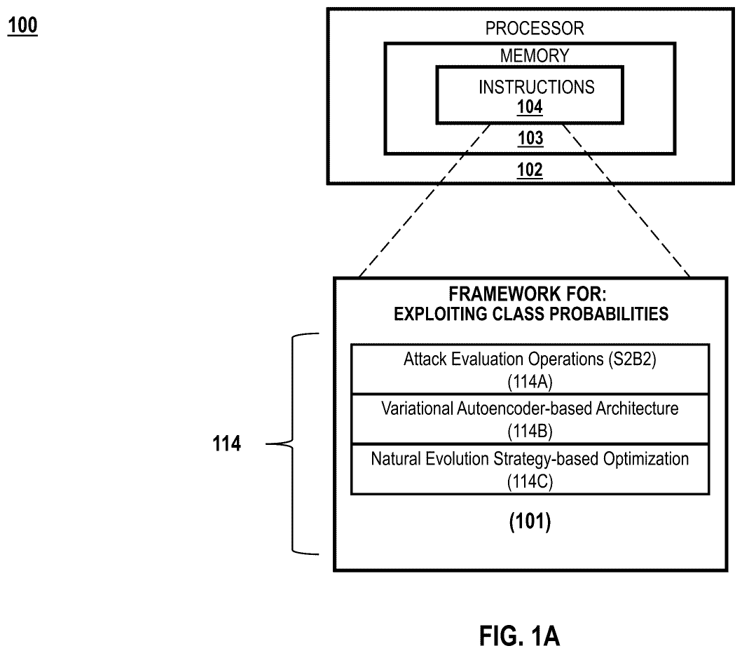

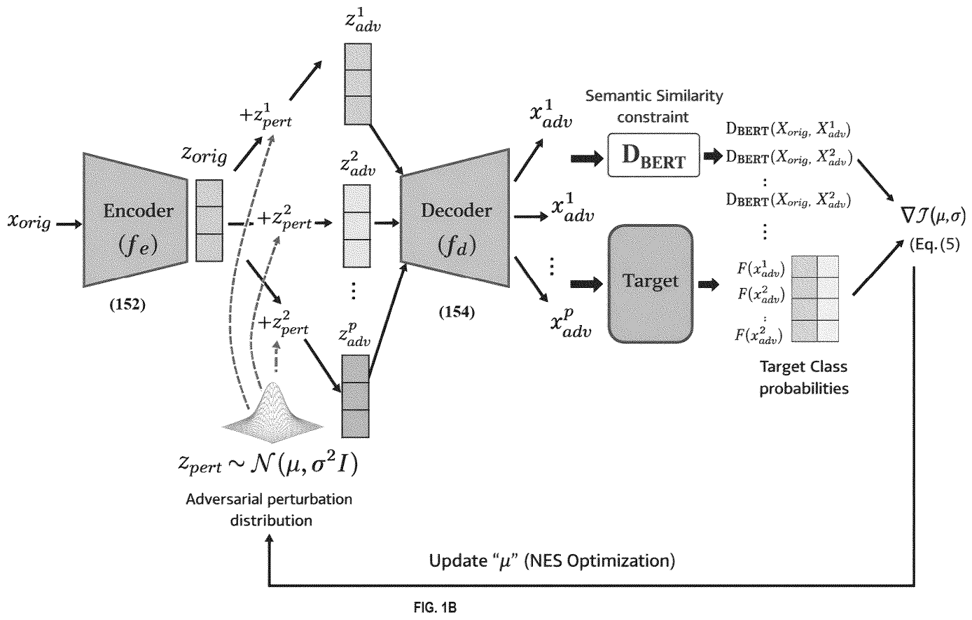

In view of the foregoing, and referring to FIG. 1A, an inventive technical solution can be implemented in the form of a system 100 for score-based sentence-level black-box attack and vulnerability assessment. The system 100 includes a framework 101 that, e.g., exploits the classifier's class probabilities to generate sentence-level adversarial examples for technical improvements in classifier evaluation (in a black-box setting). In the non-limiting example shown, the system 100 includes at least one processor 102, and at least one of a memory 103 or storage device storing instructions 104 accessible by the processor 102. In general, the processor 102 is configured, via the instructions 104, to implement the framework 101 via a network or otherwise.

The framework 101 can define or include components 114 such as prompts, logic, and other instructions executable by the processor 102 to evaluate classifiers and support functionality and operations disclosed herein. In some examples, components 114 or services of the framework 101 can include attack evaluation operations 114A specifically designed to assess the security vulnerability of prevalent text classifiers deployed in real-world applications, a variational autoencoder-based architecture 114B that models the distribution of potential adversarial sentences, and natural evolution strategy based optimization 114C to search the space of potential disruption to identify the actual adversarial disruption. Other aspects of the framework 101 are contemplated as detailed herein.

The aforementioned instructions 104 can be implemented as code and/or machine-executable instructions executable by the processor 102 that may represent one or more of a procedure, a function, a subprogram, a program, a routine, a subroutine, a module, service, an object, a software package, a class, or any combination of instructions, data structures, or program statements, and the like. In other words, the instructions 104 or any operations performed by the processor 102 described herein may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable medium (e.g., the memory 103), and the processor 102 performs the tasks defined by the code.

Referring to FIG. 1B, one example of attack evaluation operations 114A of the framework, 101, a Score-based Sentence-level BlackBox Attack (S2B2-Attack) is illustrated that exploits the classifier's class probabilities to generate sentence-level adversarial examples. S2B2-Attack (150) includes at least (1) a continuous explorable sentence-level search space of adversarial examples and (2) a Natural Evolution Strategies-based score-based search method to explore this space using the class probabilities. In particular, S2B2-Attack characterizes the continuous sentence-level adversarial search space by modeling the candidate adversarial distributions, and utilizes a score-based sentence-level search method based on the Natural Evolution Strategies (NES) to learn the actual adversarial sentence distribution's parameters. Modeling the search space as distributions instead of individual sentences provides an explorable continuous search space that can be probed by a search method using class probabilities. This is because the search will be over the continuous space of parameters of potential adversarial distributions and not a space of discrete sentences with no quantifiable relations. Meanwhile, the NES provides a black-box score-based search method to explore the parameter space of the candidate adversarial distributions using class probabilities. The distribution search space and the NES search method together enable utilizing the class probabilities for score-based sentence-level black-box attacks.

### 3.2.1 Distribution-Based Search Space

To formulate a continuous sentence-level search space that represents adversarial sentence candidates and enables the transition from one candidate to another using the class probabilities, it is proposed to model the candidate adversarial sentence distributions for the original sentence. To parameterize this distribution, it is further proposed to use a Variational Autoencoder (VAE) from Kingma et al. (Kingma and Welling, 2013); a generative latent variable model widely used to model the sentence distribution (Li et al., 2020a. “Optimus: Organizing sentences via pre-trained modeling of a latent space” incorporated by reference herein in its entirety). A VAE includes an encoder (152) and a decoder (154). The encoder, fₑ(x)=q_{φ}(z|x), encodes the text x into the continuous latent variables z. The decoder, f_{d}(z)=p_{θ}(x|z), maps z, sampled from the encoder, to the input x. The parameters of VAE are learned via maximizing the variational lower bound:

$$ELBO = {𝔼}_{{q}_{ϕ} ( z \vert x )} [ log {p}_{θ} ( x \vert z ) ] - KL ( {q}_{ϕ} ( z \vert x ) p ( z ) ) ,$$

where p(z) is the prior distribution, typically assumed to be standard diagonal covariance Gaussian. The first term of ELBO denotes the reconstruction error, while the second term is the KL regularizer which pushes the approximate posterior towards the prior distribution.

In the VAE, latent variables learned by the encoder (z), represent the higher-level abstract concepts such as the sentence structure that guide the lower-level word-by-word generation process (Li et al., 2020a). Therefore, to model the distributions of synonymous sentences to the original sentence (i.e., potential sentence-level adversarial sentences), it is proposed to perturb the distribution of the original latent variables. Specifically, the candidate adversarial distributions for a given input sample are defined as f_{d}(z_{adv})=p(x|z_{adv}), where z_{adv} is the perturbed original latent variable, obtained by perturbing the original input's latent space (z_{orig}) with adversarial Gaussian perturbations sampled from [symbol] (μ, σ²I). μ and σ² are the expected value and variance of the adversarial perturbation distribution (learned using the classifier feedback), and f_{d}(⋅) is the decoder pre-trained on the original inputs. Note that different values of parameters (μ and σ²) result in different distributions of sentences with different structures, which form the candidate adversarial examples search space. The transition from one potential candidate to another can be performed by changing its parameters, making the search space continuous and thus explorable given the classifier's class probabilities.

Even though any text-VAE can be used, to obtain grammatical correctness and fluency, the OPTIMUS (Li et al., 2020a) was adopted, a large-scale language VAE, which parameterizes the encoder and decoder networks via multi-layer Transformer-based neural networks. The encoder is a pre-trained BERTbase and the decoder is a pre-trained GPT-2. To further ensure the grammatical correctness and fluency of the samples, the OPTIMUS was fine-tuned on the training set of the clean dataset. Note that the samples used in the subject experiments to evaluate the instant method are from the test set of the datasets, which are different from the train set used for fine-tuning.

Algorithm 1 Learning the Adversarial Sentence Distribution via
S2B2-Attack

```
  Input: Original text x_{orig} and its label y, standard deviation σ, population
size p, learning rate η, maximum number of iterations T, fₑ(·) and f_{d}(·)
pretrained encoder and decoder on original inputs.
  Output: μ, mean of the adversarial sentence distribution.
  1: Initialize μ
  2: Compute z_{orig} = fₑ(x_{orig})
  3: for t = 1, 2, ... , T do
  4: Sample δ₁, ... , δₚ ~ [symbol]  (μ, σ² I)
  $5 : \qquad Set {z}_{i}^{*} = {z}_{orig} + {δ}_{i} , {∀}_{i} = 1 , … , p$
  $6 : \qquad Compute {x}_{i}^{*} = {f}_{d} ( {z}_{i}^{*} ) , {∀}_{i} = 1 , … , p$
  $7 \text{:} \qquad Compute losses {L}_{i}^{′} ( {x}_{i}^{*} ) via Eq . ( 5 ) , {∀}_{i} = 1 , … , p$
  8: Calculate ∇μ [symbol]   (μ, σ) via Eq. (3)
  9: Set μₜ₊₁ = μₜ − η∇_{μ} [symbol] (μ, σ)
10: end for
11: return μ
```

### 3.2.2 Natural Evolution Strategies Search Method

A search method is required to effectively guide the search over the continuous space of parameters of adversarial distribution candidates and identify the optimal ones using the classifier's class probabilities. It is proposed to leverage Natural Evolution Strategies (NES) by Wierstra et al. (Daan Wierstra, Tom Schaul, Tobias Glasmachers, Y Sun, Jan Peters, and Jurgen Schmidhuber. 2014. “Natural Evolution Strategies”; incorporated by reference in its entirety). The NES learns the parameters of a distribution that minimizes the adversarial objective (Eq. (1)) on average. Formally, NES minimizes the following objective:

$$𝒥 ( μ , σ ) = {𝔼}_{p ( {x}^{*} \vert {z}_{adv} ; μ , σ )} [ ℒ ( {x}^{*} ) ] , \qquad ( 2 )$$

where [symbol] (x*) is the adversarial loss in Eq. (1). Note that the optimization in Eq.(2) is over the parameters of the distribution. The gradients of Eq. (2) are calculated as follows (Wierstra et al., 2014):

$${𝔼}_{p ( {x}^{*} \vert {z}_{adv} ; μ , σ )} [ ℒ ( {x}^{*} ) ∇ log p ( {x}^{*} \vert {z}_{adv} ; μ , σ ) ] , \qquad ( 3 )$$

which can be used to update the parameters of the distribution via gradient descent. This gradient only requires the class probabilities output, which are ideal for a score-based black-box attack.

### 3.2.3 Semantic Similarity Constraint

Even though slightly perturbing the original sentence's latent variables keeps the resultant adversarial examples close to the original ones, Eq. (2) does not explicitly restrict perturbations to be small enough to preserve the semantic similarity (refer to our experiments in Sec. 4.2.2). To limit the perturbation amount, we explicitly penalize the adversarial distribution parameters with dissimilar adversarial samples to the original samples. In particular, it is proposed to maximize the semantic similarity between the adversarial examples sampled from the adversarial distributions and original samples. The semantic similarity can be measured using the BERTScore (Zhang et al., 2019), which is widely used to measure the semantic similarity of two texts (Guo et al., 2021; Hanna and Bojar, 2021). BERTScore is a similarity score that computes the pairwise cosine similarity between the contextual embeddings of the tokens of the two sentences. Formally, let X_{orig}=(xₒ₁, xₒ₂, . . . , xₒₙ) and X_{adv}=(xₐ₁, xₐ₂, . . . , xₐₘ) be the original and adversarial sentences and φ(X_{orig})=(uₒ₁, uₒ₂, . . . , uₒₙ), φ(X_{adv})=(vₐ₁, vₐ₂, . . . , vₐₘ) be their corresponding contextual embedding generated by a language model φ. The weighted recall BERTScore is defined as follows:

$${R}_{BERT} ( {X}_{orig} , {X}_{adv} ) = {\sum }_{i = 1}^{n} {w}_{i} {max}_{j = 1 , … , m} {u}_{oi}^{T} {v}_{aj} , where {w}_{i} = \frac{idf ( {x}_{oi} )}{{\sum }_{i = 1}^{n} idf ( {x}_{oi} )} , \qquad ( 4 )$$

is the normalized inverse document frequency of the token. Since the main objective function is minimization, we also minimize the dissimilarity measured as D_{BERT}(X_{orig},X_{adv})=1−R_{BERT}(X_{orig},X_{adv}).

### 3.2.4 Optimization

Finally, our final objective is as follows:

$$ℒ ( {x}^{*} ) = max \{ 0 , log F {( {x}^{*} )}_{y} - {max log}_{i \neq y} ( {F ( {x}^{*} )}_{i} ) \} \qquad ( 5 )$$

where the first term is the original C&W loss, the second term penalizes the semantically dissimilar adversarial samples and λ is a balancing coefficient which is considered as a hyperparameter in the experiments and is chosen via grid search.

The new adversarial objective is also solved by the NES optimization as follows:

$$𝒥 ( μ , σ ) = {𝔼}_{p ( {x}^{*} \vert {z}_{adv} ; μ , σ )} [ {ℒ}^{′} ( {x}^{*} ) ] , \qquad ( 6 )$$

For simplicity, we consider σ as a hyperparameter and only solve the optimization for μ. The updates on μ are performed by gradient descent, where the gradients are calculated using Eq. (3). The complete algorithm for learning the parameters of the adversarial distribution via S2B2-Attack is shown in Algorithm 1. Once the parameters of the adversarial distribution are learned, it can be used to draw adversarial examples.

### Example Implementations of the Framework (101)

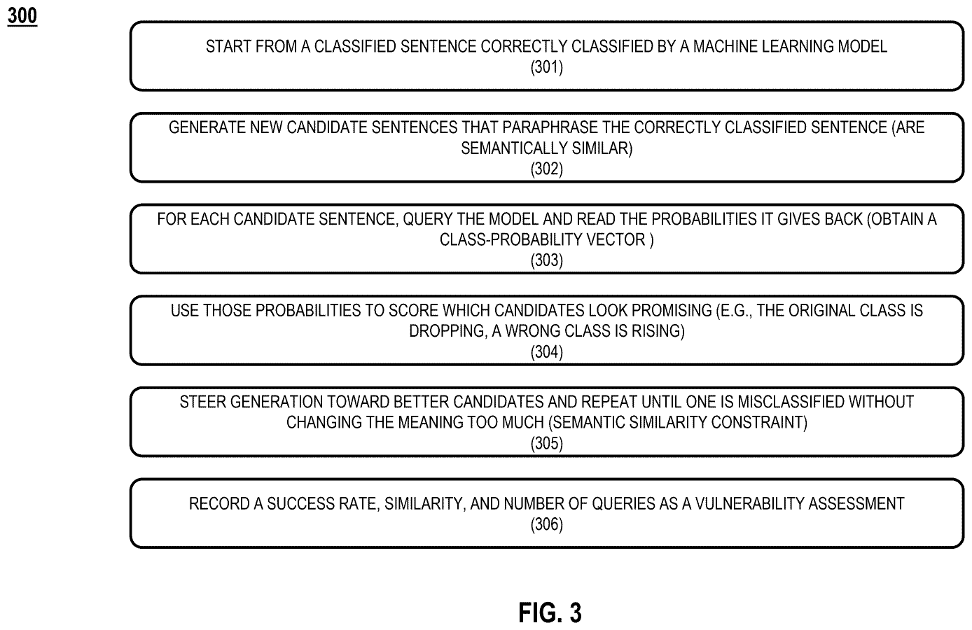

FIG. 3 illustrates a simplified example of a process 300 associated with the S2B2-Attack described herein for vulnerability assessment of a text classifier. Steps 301-306 of process 300 can be implemented to test how fragile a text classifier by assessment of class probabilities (as opposed to its internals).

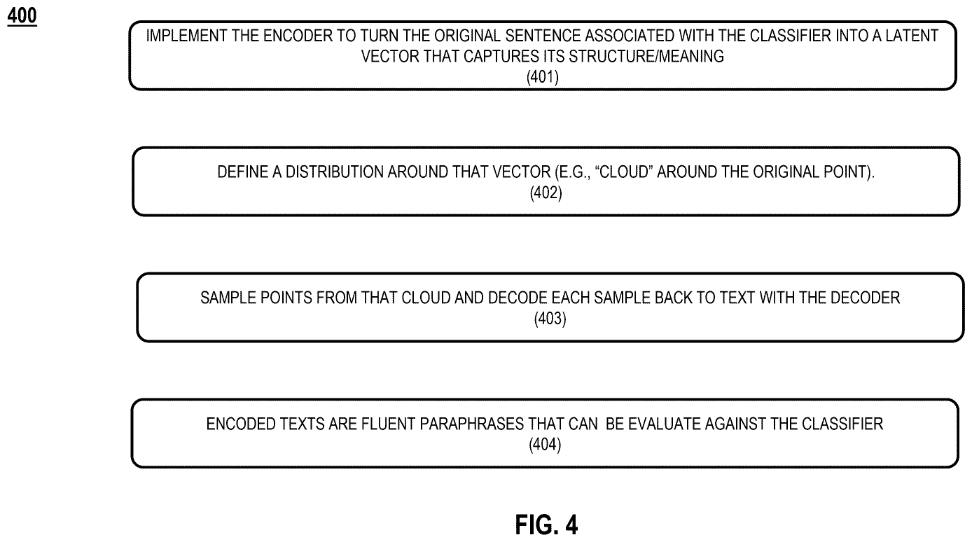

FIG. 4 illustrates a simplified example of a process 400 associated with a variational autoencoder (VAE) architecture described herein for modeling adversarial sentence distributions. Steps 401-404 of process 400 illustrate use of a continuous latent space of sentences rather than jumping between disconnected paraphrases to output stream of well-formed candidate sentences.

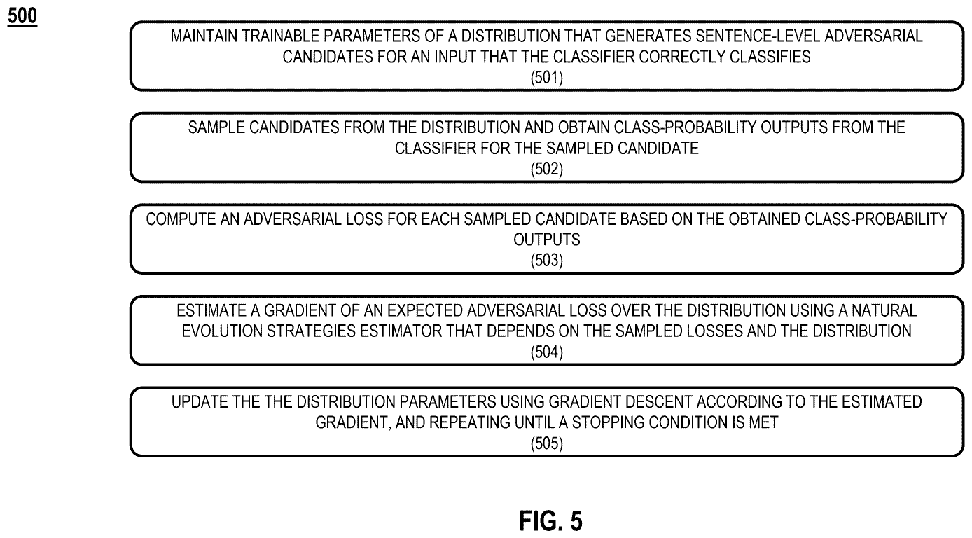

FIG. 5 illustrates a simplified example of a process 500 associated with natural evolution strategy based optimization described herein. Steps 501-505 of process 500 illustrate steps to effectively guide the search over the continuous space of parameters of adversarial distribution candidates and identify the optimal ones using the classifier's class probabilities.

### 4. Experiments

Comprehensive experiments were conducted to evaluate the effectiveness of S2B2-Attack. The experiments centered around three main questions: (i) Does utilizing the class probabilities improve the success rates of sentence-level attacks? (ii) How does each component of the S2B2-Attack contribute to its performance (ablation study)? and (iii) Are examples generated by S2B2-Attack grammatically correct and fluent? Some adversarial samples generated by S2B2-Attack are presented in the Appendix provided herein.

### 4.1 Experimental Setting

### 4.1.1 Datasets and Classifier Models

The commonly-used text classification datasets with different characteristics were leveraged, i.e., datasets on different classification tasks such as news and sentiment classification on both sentence and document levels. The AG's News (AG) (Zhang et al., 2015) was used, which is a sentence-level dataset, and IMDB (https://datasets.imdbws.com/), and Yelp (Zhang et al., 2015) that are document-level datasets. The experiments were conducted on three state-of-the-art transformer-based classifiers, i.e., fine-tuned BERT base-uncased (Devlin et al., 2018), Roberta (Liu et al., 2019), and XLNet (Yang et al., 2019).

TABLE 1
Evaluation results of the proposed S2B2-Attack and baselines on AG's news
(AG), and IMDB datasets. The performance is measured by the
Attack Success rates (ASR) (↑) and USE-based Semantic Similarity (USE) (↑).

| | | BERT | | ROBERTA | | XLNet | |
|---|---|---|---|---|---|---|---|
| Dataset | Attack | ASR (↑) | USE (↑) | ASR (↑) | USE (↑) | ASR (↑) | USE (↑) |
| AG | S2B2-Attack | 81.2 | 0.7210 | 83.6 | 0.7200 | 80.9 | 0.7012 |
| | MAYA-score | 75.2 | 0.5582 | 77.1 | 0.5422 | 75.3 | 0.5411 |
| | GAN-based | 70.2 | 0.6211 | 72.2 | 0.6201 | 68.6 | 0.6036 |
| | MAYA-decision | 71.3 | 0.5421 | 73.6 | 0.5615 | 69.9 | 0.5127 |
| | SCPN | 63.4 | 0.5833 | 67.4 | 0.5921 | 63.1 | 0.5904 |
| | SynPG | 66.8 | 0.5091 | 67.1 | 0.5381 | 66.1 | 0.5028 |
| IMDB | S2B2-Attack | 62.2 | 0.6493 | 65.0 | 0.6536 | 63.5 | 0.6683 |
| | MAYA-score | 54.7 | 0.4564 | 57.6 | 0.4771 | 52.6 | 0.4289 |
| | GAN-based | 44.6 | 0.5128 | 48.4 | 0.5186 | 45.1 | 0.5012 |
| | MAYA-decision | 49.8 | 0.4621 | 50.9 | 0.4581 | 46.2 | 0.4616 |
| | SCPN | 38.2 | 0.4351 | 42.2 | 0.4318 | 39.2 | 0.4451 |
| | SynPG | 35.1 | 0.3889 | 35.7 | 0.3881 | 36.1 | 0.3817 |
| Yelp | S2B2-Attack | 66.9 | 0.7126 | 66.9 | 0.7374 | 64.1 | 0.7020 |
| | MAYA-score | 52.8 | 0.4779 | 54.1 | 0.4612 | 52.9 | 0.4661 |
| | GAN-based | 38.6 | 0.4797 | 36.5 | 0.4489 | 40.5 | 0.4944 |
| | MAYA-decision | 48.9 | 0.4791 | 49.1 | 0.4819 | 46.9 | 0.4759 |
| | SCPN | 48.2 | 0.4472 | 48.9 | 0.4672 | 45.3 | 0.4518 |
| | SynPG | 45.1 | 0.3918 | 43.9 | 0.4146 | 45.0 | 0.3971 |

### 4.1.2 Compared Methods

Existing black-box sentence-level attacks are mainly blind or decision-based. S2B2-Attack was compared with two state-of-the-art in each category. (1) Blind attacks. these attacks do not utilize the classifier feedback at all and use the paraphrases of the original sentences as adversarial examples. SCPN (lyyer et al., 2018) and SynPG (Huang and Chang, 2021) are two state-of-the-arts in this category; (2) Decision-based attacks. These attacks only use the classifier class labels to verify if a candidate example is adversarial. GAN-based attack (Alzantot et al., 2018b) and MAYA-decision (Chen et al., 2021) are two state-of-the-arts in this category. For crafting the search space, GAN-based attack uses adversarial networks (Goodfellow et al., 2014) and MAYA-decision adopts paraphrase generation. For the search method, both GAN-based and MAYA use iterative search. For the sake of fair comparison, we use the sentence-level variation of MAYA. To be comprehensive, an extension of MAYA, named MAYA-score was adopted, to the score-based setting, that adopts heuristic search (selecting the sample with the least original class probability) among the candidates generated with paraphrase generation. It is believed that no other sentence-level adversarial attack under the subject score-based setting exists.

### 4.1.3 Evaluation Metrics

The Attack Success Rate (ASR) was reported, which is the proportion of misclassified adversarial examples to all correctly classified samples, and Universal Sentence Encoder-based semantic similarity metric (SS) (Cer et al., 2018) to measure the similarity between the original input and the corresponding adversarial. Note that to make a fair comparison, a commonly-used metric was chosen which is different from BERTScore-based constraint used in the proposed S2B2-Attack. For grammatical correctness and fluency, we report the increase rate of grammatical error numbers of adversarial examples compared to the original inputs measured by the Language-Tool (IER), and GPT-2 perplexity (Prep.) (Radford et al., 2019), respectively.

### 4.2 Evaluation Results

### 4.2.1 General Comparisons

To demonstrate the effect of exploiting the class probabilities on the attack's success, the proposed S2B2-Attack and state-of-the-art sentence-level black-box attacks were evaluated with the results reported in Table 1. As shown in the table, S2B2-Attack significantly outperforms all baselines for all classifiers on all datasets. Specifically: (i) not utilizing the classifier feedback at all, the blind baselines, i.e., SynPG and SCPN demonstrate the lowest Attack Success Rates (ASR); (ii) the decision-based baselines (GAN-based and MAYA-decision), outperform the blind attacks. This is because they employ the classifier class labels to ensure that the generated example is adversarial, leading to more successful adversarial examples; (iii) MAYA-score, the score-based variation of MAYA-decision, outperforms both blind and decision-based baselines. This highlights the impact of leveraging class probabilities on guiding the adversarial example generation and crafting more successful attacks; (iv) the proposed S2B2-Attack outperforms the MAYA-score, the only existing score-based sentence-level attack. This is because MAYA-score uses a heuristic search method based on selecting the candidate with the lowest original class probability from the discrete search space of candidates generated using paraphrase generation methods. S2B2-Attack, on the other hand, is equipped with NES search method that fully utilizes the classifier's class probabilities to guide the generation of adversarial examples over the proposed continuous distribution-based search space.

### 4.2.2 Decomposition and Parameter Analysis

A detailed analysis of the effect of the search method is provided and the proposed semantic similarity constraint on that attack's performance.

Search Method. To demonstrate the search method's effect, we compare the performance of each search method for different fixed search spaces as follows: (1) Distribution: our proposed search space that models the candidate distributions of adversarial examples; (2) GAN: the search space generated via generative adversarial networks as in GAN-based baseline (Zhao et al., 2017); and (3) paraphrase: utilized by the rest of the baselines, this method generates paraphrases of the original sentences. For the paraphrase generation, we use the method as MAYA (Chen et al., 2021). We compare our proposed search method NES (NES-score), which fully leverages the class probabilities classifier feedback, heuristic method as used in MAYA-score, that selects the candidate adversarial example with the lowest original class probability (heuristic-score), decision method that employs the class labels iteratively to verify if the generated candidates are adversarial as used in the GAN-based, and blind search in which no search is employed. Note that since the GAN and paraphrase-based search spaces are not discrete and thus explorable by the class probability feedback as required by the NES-score search, we only report the results for heuristic-score, decision, and blind search for these search spaces. Moreover, to make fair comparisons, we do not include any explicit semantic similarity constraints for any of the methods. Our results shown in Table 2 reveal the following: (i) empowered by utilizing the class probabilities, the score search methods (NES-score and heuristic-score) outperform both decision and blind search for a fixed search space; (ii) For a given search space, NES-score outperforms the heuristic-score constantly, since it fully leverages the classifier's class probabilities to guide the adversarial example generation. Meanwhile, the heuristic-score only uses the class-probabilities to select the potential adversarial example and not generating it; (iii) the decision method constantly outperforms the blind search for all search spaces. This is because the decision method partially employs the classifier feedback (class labels) to verify whether the example is adversarial or not. Blind search, on the other hand, is deprived of classifier feedback which leads to lower success rates; and (iv) fixing the search method, paraphrase-based attacks achieve the lowest semantic similarity. This is mainly because in this search space, the candidate adversarial examples are generated using pre-defined syntax that may change the meaning of the original sentence (e.g., from a declarative sentence to an interrogative sentence). GAN-based attacks preserve higher semantic similarity compared to the paraphrase, suggesting that perturbing the latent space of the original examples can successfully generate semantically similar sentences. However, they still fall behind their corresponding Distribution-based attacks that model the distribution of adversarial candidates using VAE. We believe this is due to the GAN's instability (Kodali et al., 2017) which may result in a drastic change of semantic similarity by a slight change of latent variable. This observation further proves that besides its evident advantage of being explorable by the class probability feedback, our Distribution search space can also generate adversarial candidates with higher semantic similarity.

TABLE 2
Results of ablation study on AG and IMDB
datasets. The classifier model is BERT.

| Search | Search | AG | | IMDB | |
|---|---|---|---|---|---|
| Space | Method | ASR(↑) | USE (↑) | ASR(↑) | USE (↑) |
| Distribution | NES-score | 81.2 | 0.7210 | 62.2 | 0.6493 |
| | heuristic-score | 77.3 | 0.6819 | 52.3 | 0.0.5571 |
| | decision | 75.4 | 0.6680 | 45.9 | 0.5532 |
| | blind | 69.1 | 0.6631 | 40.1 | 0.4969 |
| GAN | NES-score | N/A | N/A | N/A | N/A |
| | heuristic-score | 73.1 | 0.6119 | 0.57.4 | 0.4980 |
| | decision | 70.2 | 0.6211 | 44.6 | 0.5128 |
| | blind | 62.9 | 0.6026 | 38.9 | 0.4468 |
| Paraphrase | NES-score | N/A | N/A | N/A | N/A |
| | heuristic-score | 75.2 | 0.5582 | 54.7 | 0.4564 |
| | decision | 68.1 | 0.5878 | 42.9 | 0.4989 |
| | blind | 63.4 | 0.5833 | 38.2 | 0.4351 |

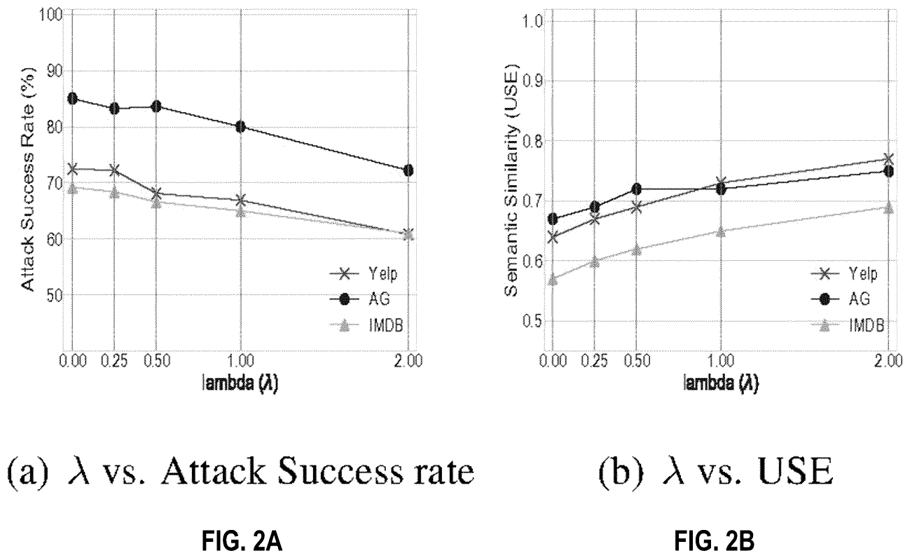

Semantic Similarity Constraint. To examine the impact of the semantic similarity constraint on the S2B2-Attack's performance, we vary the semantic similarity coefficient (λ in Eq. (5)) in the range {0, 0.25, 0.5, 1, 2} and report S2B2-Attack's Attack Success Rate (ASR) and Semantic Similarity (USE) as shown in FIGS. 2A-2B. λ=0 indicates not using the semantic similarity constraint at all. As can be seen in the figures, the decreasing graph of ASR and the increasing graph of the USE vs λ demonstrate a trade-off between obtaining higher success rates and semantic similarities. Our experiments show that λ=0.5 and λ=1 are the optimal values for ASR and USE for AG, IMDB, and Yelp datasets.

TABLE 3
Quality evaluation of adversarial examples attacking BERT in terms of
Increase Error Rate (IER) (↓) and perplexity (Prep.) (↓).

| | IMDB | | Yelp | |
|---|---|---|---|---|
| Attack | IER (↓) | Prep. (↓) | IER (↓) | Prep. (↓) |
| S2B2-Attack | 1.45 | 98.61 | 1.67 | 109.77 |
| MAYA-score | 1.90 | 116.43 | 2.17 | 162.11 |
| GAN-based | 2.98 | 136.92 | 3.22 | 175.17 |
| MAYA-decision | 1.83 | 121.87 | 2.29 | 171.25 |
| SCPN | 3.93 | 164.91 | 3.86 | 186.32 |
| SynPG | 4.61 | 238.18 | 4.91 | 264.81 |

### 4.2.3 Query Complexity Analysis

As described in Algorithm 1, in each iteration, the S2B2-Attack attack makes P to the target to obtain target class probabilities for the P samples drawn from the distribution. This brings the total number of queries for T iterations to P×T, with the average query time of O(P×T). In our experiments, the number of iterations (T) is set to 50, and the number of samples drawn per iteration (P) is set to 20. Consequently, a maximum of 50×20=1000 queries per sample are executed on the target model.

It is worth mentioning that this is similar to the query budgets of the state-of-the-art black-box word-level attacks. For the sake of comparison, consider the TextFooler, one of the strongest and most query-efficient word-level black-box attack (Jin et al., 2020). This attack requires 1130.4 and 750 queries per sample on average to attack the BERT classifier on the IMDB dataset (Maheshwary et al., 2021). In comparison, our proposed sentence-level attack, in its worst case, demands a comparable number of queries to the state-of-the-art word-level black-box attacks. Since the word-level black-box attacks with these query budgets are shown to be undetectable by the current defenses based on query-complexity, similarly, our proposed attack will not be recognized by the current defenses based on query complexity, and therefore will be suitable for real-world deployment.

### 4.2.4 Quality of the Adversarial Examples

We examine the grammatical correctness and fluency of the adversarial examples generated by S2B2-Attack. The evaluation results are shown in Table 3. Our results demonstrate that S2B2-Attack outperforms all baselines in terms of fluency and grammatical correctness. The gain is due to use of a language model-based decoder fine-tuned on the clean dataset to generate the adversarial examples. This ensures that the learned distribution of the adversarial examples is close to the original distribution, benefiting from the properties of that distribution (i.e., fluency and some grammatical correctness) while retaining different structures imposed by latent variable distributions.

### 5. Non-Limiting Conclusion

As demonstrated by the experiments and testing described herein, leveraging class probabilities significantly improves the success rates of sentence-level attacks, as the S2B2-Attack achieves approximately 15% of improvement over the state-of-the-art decision-based attack (Table 1, Sec. 4.2). This gain justifies the use of class probabilities in guiding the adversarial example generation and reducing the search space of potential adversarial examples. It is important to note that the class probabilities are the most common type of feedback returned by the classifier and are widely available to use, e.g., Microsoft Azure. In fact, their availability and effectiveness have given rise to many score-based word-level attacks (Jin et al., 2020; Li et al., 2020c). The proposed S2B2-Attack makes the usage of class probabilities for sentence-level practically feasible.

### A. APPENDIX

### A.1 Reproducibility

### A.1.1 S2B2-Attack Implementation

Experiments were conducted on a 24 GB RTX-3090 GPU. By non-limiting example, the proposed S2B2-Attack was implemented in PyTorch. To parameterize the candidate adversarial distribution, the pre-trained OPTIMUS was used. For each dataset, the pre-trained OPTIMUS was fine-tuned on the training set of the clean dataset for 1 epoch. The variance of the adversarial distribution σ² was fixed to “1” for all experiments. The hyperparameter λ (balancing coefficient in Eq. (5)) is selected via grid search from the {0.25, 0.5, 1, 2}. For all experiments, optimization is solved via gradient descent with a learning rate 0.01.

### A.1.2 Baseline Implementation

For the SCPN and GAN-based attacks, the implementation and pre-trained weights from OpenAttack (Zeng et al., 2020) were used, a widely-used open-source repository for NLP adversarial attacks. For the MAYA-score and MAYA-decision, the official implementation by the authors was used (https://github.com/Yangyi-Chen/MAYA). The SynPG baseline was also conducted using the authors' official implementation (https://github.com/uclanlp/synpg).

### A.2 Case Study

Table 4 and 5 showcase generated adversarial examples by the S2B2-Attack. As shown in the table, S2B2-Attack successfully generates sentence-level adversarial paraphrases of the original sentences, i.e., sentences that are semantically similar to the original examples, but their structures are grammatically different. These adversarial examples are misclassified by the classifier with high probabilities. Moreover, they are grammatically correct and fluent, further verifying the S2B2-Attack's effectiveness in providing grammatical correctness and fluency, two important properties of successful indefensible adversarial examples.

### A.3 Potential Risks

The research herein aims to develop an algorithm that can effectively exploit the vulnerability of existing text classification algorithms and thus provide secure, robust, and reliable environments for real-world deployments. In addition to robustifying the environments, our attack can also be used to debug the model and detect its biases. However, one of the primary risks associated with developing adversarial attacks is the potential for malicious use, such as potential misinformation and disinformation campaigns. Adversarial attackers can exploit vulnerabilities in text-based systems, such as social media platforms or news websites, to spread false information, manipulate public opinion, or incite social unrest. Another risk lies in the potential for unintended consequences. Adversarial attacks can have unintended side effects, such as biased or discriminatory outputs, which can perpetuate existing societal inequalities or amplify harmful stereotypes.

TABLE 4
Adversarial examples generated by S2B2-Attack on BERT classifier trained on the Yelp dataset.

| | Orig. | | Adv. |
|---|---|---|---|
| Original | Label | Adversarial | Label |
| the absolute worst service I have | Negative | the service here is, without a doubt, the | Positive |
| ever had at any bar or restaraunt. | | worst I've experienced at any bar or | |
| And, in looking at other reviews, I | | restaurant. Judging by other reviews, I'm | |
| am not the first. There are many | | not the only one with this opinion. With | |
| options at the Waterfront, and I | | numerous options available at the | |
| would suggest you try any of them; | | Waterfront, I recommend exploring | |
| but stay far away from this place! | | alternatives. However, it's advisable to | |
| | | steer clear of this particular place! | |
| wings are overpriced. And the | Negative | the wings are excessively priced, and their | Positive |
| quality of them are bad. They were | | quality is mediocre-tough and greasy. | |
| tough and greasy. The staff are | | The staff is amiable, but the overall | |
| pleasant but then over all | | experience proved to be too expensive for | |
| experience was too expensive for a | | a sports bar. | |
| sports bar. | | | |
| this is a very small, yet nice store. | Positive | this store is small but enjoyable. The staff | Negative |
| The associates are nice and | | is friendly and helpful. There isn't much | |
| helpful. Not much else to say about | | else to say about this particular store. | |
| this particular store. Just a | | Making a purchase here is a pleasure. | |
| pleasure to purchase from . . . | | | |
| really hard to find a good cup of | Positive | it's quite challenging to find a quality cup | Negative |
| coffee in the states . . . I'd say | | of coffee in the United States. I would say | |
| this is the best cappuccino I've had | | this cappuccino is the finest I've had since | |
| since Italy. | | Italy. | |

TABLE 5
Adversarial examples generated by S2B2-Attack on BERT classifier trained on the AG news dataset.

| | Orig. | | Adv. |
|---|---|---|---|
| Original | Label | Adversarial | Label |
| The New Customers Are In Town | Business | new customers have arrived in town, and | World |
| To-day's customers are | | the present trend reflects growing | |
| increasingly demanding, in Asia as | | expectations among consumers, not just | |
| elsewhere in the world. Henry | | in Asia but on a global scale. Henry | |
| Astorga describes the complex | | Astorga elucidates the complex | |
| reality faced by today's marketers, | | challenges faced by today's marketers, | |
| which includes much higher | | encompassing expectations that exceed | |
| expectations than we have been | | our accustomed norms. Modern | |
| used to. Today's customers want | | customers emphasize immediate and | |
| performance, and they want it now! | | high-performance results. | |
| Bangkok's Canals Losing to Urban | Sci/Tech | the canals of Bangkok are falling prey to | Business |
| Sprawl (AP) AP - Along the banks | | the advance of urban development, | |
| of the canal, women in rowboats | | illustrated by images of women grilling fish | |
| grill fish and sell fresh bananas. | | and selling fresh bananas from rowboats | |
| Families eat on floating pavilions, | | along the canal edges. Floating pavilions | |
| rocked gently by waves from | | provide a setting for families to dine, | |
| passing boats. | | gently rocking with the waves created by | |
| | | passing boats. | |
| The Geisha Stylist Who Let His Hair | World | in the Gion geisha district of Japan's | Business |
| Down Here in the Gion geisha | | ancient capital, even one unfavorable | |
| district of Japan's ancient capital, | | hairstyle can pose a threat to a girl's | |
| even one bad hair day can cost a | | professional prospects. Therefore, it's | |
| girl her career. So it is no wonder | | clear why Tetsuo Ishihara is the most | |
| that Tetsuo Ishihara is the man with | | highly sought-after stylist in the region. | |
| the most popular hands in town. | | | |
| British eventers slip back Great | Sports | British eventers drop to third place | World |
| Britain slip down to third after the | | following the cross-country round of the | |
| cross-country round of the three- | | three-day eventing. | |
| day eventing. | | | |

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

What is claimed is:

1. A method for assessing the security vulnerability of a machine learning model operating in a black-box score-based setting, comprising:
(a) receiving an input sentence that a text classifier correctly classifies;
(b) generating, based on the input sentence, one or more candidate sentence-level variants that are intended to be semantically similar to the input sentence;
(c) for each candidate sentence-level variant, querying the text classifier and obtaining a class-probability vector as feedback;
(d) computing an adversarial loss for the candidate sentence-level variant as a function of the obtained class-probability vector, the adversarial loss increasing as the probability of a non-original class increases and decreasing as the probability of the original class increases;
(e) updating a generation policy for the candidate sentence-level variants based at least on the class-probability vectors so as to produce, in subsequent iterations, candidate sentence-level variants more likely to be misclassified by the text classifier; and
(f) determining that the text classifier is vulnerable when a candidate sentence-level variant is misclassified while satisfying a semantic-similarity threshold relative to the input sentence to provide score-driven, sentence-level robustness evaluation that exploits class-probability feedback.

2. The method of claim 1, wherein (b) enforces a semantic-similarity threshold using an embedding-based similarity measure comprising one or more of: BERTScore, Universal Sentence Encoder similarity, cosine similarity between sentence embeddings, or combinations thereof.

3. The method of claim 1, wherein the adversarial loss of (d) comprises a misclassification objective based on class probabilities including a Carlini-and-Wagner-style term that penalizes the log-probability margin between the original class and the highest non-original class.

4. The method of claim 1, further comprising iteratively generating and evaluating a population of candidate sentence-level variants per iteration and aggregating class-probability feedback across the population to update the generation policy.

5. The method of claim 1, wherein determining vulnerability in step (f) further comprises computing one or more vulnerability metrics selected from: attack success rate, semantic similarity score, query count, language-model perplexity, and grammar-error rate.

6. The method of claim 1, wherein the text classifier is a neural network text classifier comprising a transformer-based model.

7. The method of claim 1, further comprising enforcing a query-budget and stopping criterion that terminates the method when (i) a misclassification satisfying the semantic-similarity threshold is found or (ii) a maximum number of classifier queries is reached.

8. The method of claim 1, wherein step (e) supports untargeted and targeted variants, the targeted variant increasing a probability of a specified target class according to the class-probability feedback.

9. The method of claim 1, further comprising logging for auditability: the input sentence, generated candidates, corresponding class-probability vectors, adversarial loss values, and generation-policy updates.

10. The method of claim 1, wherein generating candidate sentence-level variants comprises using a generative or editing model constrained to maintain fluency and grammaticality, as measured by a perplexity threshold and/or a grammar-error threshold.

11. A method for assessing the security vulnerability of text classifiers to adversarial attacks before deployment, comprising:
accessing as input a sequence of classified texts predetermined to be correctly classified;
generating corresponding sentences that are synonymous with the input but are misclassified by one or more classifiers;
assessing security vulnerability of the one or more classifiers by leveraging class probabilities to provide an increase in success rate of sentence level attacks.

12. The method of claim 11, further comprising perturbing a distribution of original latent variables of the input.

13. The method of claim 11, further comprising:
generating a candidate adversarial distribution for the input defined as f_{d}(z_{adv})=p(x|z_{adv}), where z_{adv} is the perturbed original latent variable, obtained by perturbing the original input's latent space (z_{orig}) with adversarial Gaussian perturbations sampled from [symbol] (μ, σ²I), wherein μ and σ² are the expected value and variance of the adversarial perturbation distribution (learned using the classifier feedback), and f_{d}(⋅) is the decoder pre-trained on the original inputs.

14. The method of claim 11, further comprising leveraging the class probabilities by formulating a continuous sentence-level search space that represents adversarial sentence candidates associated with the input and enables transition from one candidate to another using the class probabilities.

15. A system for modeling a distribution of potential adversarial sentences for improved classifier vulnerability assessment, the system comprising:
one or more processors and memory storing instructions executable by the one or more processors to:
(a) implement a text variational autoencoder (VAE) latent variable model configured to model sentence distribution and having an encoder and a decoder;
(b) obtain, for an input sentence, a latent representation using the encoder;
(c) parameterize an adversarial latent distribution as a perturbation of the latent representation, the perturbation drawn from a distribution having parameters including a mean vector and a variance; and
(d) sample latent variables from the adversarial latent distribution and decode the sampled latent variables via the decoder to produce candidate adversarial sentences representing a continuous, explorable search space of sentence-level variants that accommodates a continuous, parameterized search space in latent space to support score-guided exploration and preserve fluency and semantics, thereby improving effectiveness of classifier vulnerability assessment.

16. The system of claim 15, wherein the encoder comprises a Transformer-based model selected from BERT, RoBERTa, or XLNet, and the decoder comprises an autoregressive Transformer selected from GPT-2 or a functionally equivalent model, the encoder and decoder being fine-tuned on a clean corpus that is different from an evaluation test set.

17. The system of claim 15, wherein the adversarial latent distribution is a Gaussian distribution with diagonal covariance, and the perturbation is applied additively to the latent representation by adding a noise vector to the original latent representation, the distribution having a mean that is adjustable during optimization while the variance is held fixed.

18. The system of claim 15, further comprising a semantic-similarity module configured to compute embedding-based similarity between a decoded candidate sentence and the input sentence using BERTScore, Universal Sentence Encoder similarity, cosine similarity in a sentence-embedding space, or any combination thereof, and to filter or score candidate sentences according to a similarity threshold.

19. The system of claim 15, further comprising a population sampler configured to generate a specified number of decoded candidate sentences per iteration using one or more of temperature-controlled sampling, top-k sampling, or nucleus (top-p) sampling, and quality filters configured to evaluate language-model perplexity and grammar-error rate against respective thresholds.

20. The system of claim 15, wherein the text variational autoencoder is trained to maximize an evidence lower bound objective using a standard normal prior over latent variables and a reparameterization method that enables gradient-based training, and the system further comprises a model artifact registry to store encoder and decoder checkpoints, latent-distribution mean and variance parameters, and configuration metadata for reproducibility and audit.
